(19) United States
(12) Patent Application Publication
(10) Pub. No.: US 2019/0033168 A1
(43) Pub. Date: Jan. 31, 2019

(54) TOOTHING ARRANGEMENT AND METHOD FOR DETERMINING CHARACTERISTICS OF A TOOTHING ARRANGEMENT

(71) Applicant: BESTSENS AG, Coburg (DE)

(72) Inventors: Christoph BRUECKNER, Forchheim (DE); Wolfgang DILLER, Coburg (DE); Sebastian STICH, Roedental (DE)

(73) Assignee: BESTSENS AG, Coburg (DE)

(21) Appl. No.: 16/077,019

(22) PCT Filed: Feb. 10, 2017
(86) PCT No.: PCT/EP2017/053050

§ 371 Date: Aug. 9, 2018

(30) Foreign Application Priority Data
Feb. 12, 2016 (DE) 10 2016 202 176.1

(51) Int. Cl. G01M 13/02; G01N 29/04; G01N 29/14; G01N 29/24; G01N 29/44

(52) U.S. Cl. CPC G01M 13/021; G01N 29/041; G01N 29/14; G01N 29/2462; G01N 29/2475; G01N 2291/2696; G01N 2291/015; G01N 2291/0258; G01N 2291/0423; G01N 2291/102; G01N 29/4454

(57) ABSTRACT

The invention relates to a toothing arrangement, having at least one first element (11) which has a toothing (111), and having at least one second element (12) which interacts with the first element (11). According to the invention, at least one receiver (3) is provided which is arranged on the first or on the second element (11, 12) and which serves for receiving acoustic waves (SAW) which are incited in the first and/or second element (11, 12), wherein information regarding characteristics of the toothing arrangement (1) can be determined through evaluation of a signal which is generated by the receiver (3) upon receipt of the acoustic waves (SAW).

The invention relates to a gearing arrangement according to the precharacterizing clause of claim 1 and a method for determining properties of a gearing arrangement according to the precharacterizing clause of claim 16.

Gearing arrangements are used in a variety of areas of the technology, for example as a component of transmissions. A gearing arrangement comprises at least one first element, which cooperates with at least one further element (in particular with positive locking) via a gearing. The second element likewise has a gearing, for example, or another structure (for instance the thread-like structure of a worm cooperating with a worm gear), in which the gearing of the first element engages. A problem when using gearings (gearing arrangements) is that the state of components of the gearing arrangement can only be checked with difficulty during operation the of the gearing arrangement.

The problem on which the invention is based consists in also determining properties of components of a gearing during operation.

This problem is solved by the gearing arrangement according to claim 1 and by the method according to claim 16.

Accordingly, a gearing arrangement is provided, having
at least one first element, which has a gearing; and
at least one second element, which cooperates with the first element; and
at least one receiver arranged on the first or the second element for receiving acoustic waves excited in the first and/or the second element, wherein information relating to properties of the gearing arrangement can be determined by evaluating an (electrical) signal generated by the receiver upon receiving the acoustic waves.

In principle, the invention can be used with any components of a gearing arrangement. For example, the first element of the gearing arrangement is designed as a gear wheel, which cooperates with a second element in the form of a further gear wheel or a gear rack. It is also conceivable that the first element is a ring gear of a planetary transmission, i.e. an element having a gearing formed along an inner circumference.

The gearing arrangement according to the invention can also have at least one transmitter for exciting acoustic waves in the first and/or second element, wherein the receiver, in particular, identifies the acoustic waves generated by the transmitter. For example, the transmitter is designed to excite surface acoustic waves in the first and/or second element. In particular, the transmitter is designed such that it can excite surface acoustic waves in the form of Lamb waves or Lamb-Rayleigh waves in the first and/or second element, which waves propagate from the transmitter to the receiver. For example, for generating Lamb waves, surface acoustic waves are generated in a region of the first and/or the second element which has a relatively small thickness (which is in particular smaller than the wave length of the excited surface acoustic waves). The frequency of the surface waves is selected depending on the thickness of the first or second element, e.g. frequencies in the range between 50 kHz and 2 MHz or in the range between 800 kHz and 1.5 MHz are used.

For example, information relating to the state (e.g. temperature, composition and/or a change in these properties) of a lubricant of the gearing arrangement (which is located in particular between the first and the second element) can be obtained by evaluating the receiver signal. Some of the surface acoustic waves generated in the first or the second element will decouple in the lubricant, in particular when the acoustic velocity in the lubricant is lower than the velocity of the surface acoustic waves (which is the case for conventional lubricants, for instance oil).

The decoupling of some of the surface acoustic waves results in a change in the receiver signal, wherein the change depends on the nature of the lubricant. For example, the amplitude of the receiver signal will change depending on the quantity of lubricant, so that (after a corresponding calibration) it is possible to derive information relating to the quantity of lubricant (e.g. the thickness of a lubricant film present between the first and the second element) by evaluating the signal amplitude, for example.

The evaluation of the receiver signals takes place in particular via an evaluating unit, which is realized for example by a programmable device which is programmed accordingly. It is conceivable that the evaluating unit is arranged at a spacing from the receiver, wherein the receiver signals are transmitted for example by radio to the evaluating unit.

According to another further development of the invention, both the receiver and the transmitter are arranged on the first element. It is naturally also conceivable that the receiver and the transmitter are arranged on the second element. For example, as already mentioned, the first element is a ring gear (in particular of a planetary transmission, e.g. with an internal gearing), wherein the transmitter and the receiver are arranged on an outer side of the ring gear. It is also possible that the first element is a bevel gear, a crown gear, a hybrid gear or an elliptical gear.

For example, acoustic waves are excited by the transmitter, which propagate along the gearing of the first and/or the second elements, and which also propagate in particular along a contact surface between the gearing of the first element and the second element (in particular a gearing of the second element).

For example, the receiver and the transmitter are arranged on a side of the first element which is remote from the gearing, or the receiver and the transmitter are arranged on a side of the second element which is remote from a gearing.

It is also possible that, as already mentioned above, the first element is a gear wheel and both the transmitter and the receiver are arranged on or in the gear wheel (which is designed for instance in the form of a pinion). In particular, the gear wheel has an external gearing and has an (e.g. central) opening, wherein the transmitter and the receiver are arranged in the opening. In another variant, the second element is designed as a gear rack, wherein both the transmitter and the receiver are arranged on the gear rack. For example, the gear rack is fixed (i.e. fastened to a holding structure outside the gearing arrangement). However, it is also possible that the gear rack is movable with the transmitter and the receiver. In particular, the transmitter and the receiver are arranged on a side of the second element (in particular in the form of a further gear wheel or a gear rack) which is remote from the first element (in particular in the form of a gear wheel).

According to another embodiment of the invention, tooth flanks of the gearings of the first and the second elements extend in a curve or at an angle to a movement direction of the first or the second element. It is also conceivable that the gearings of the first and the second element form a cycloidal gearing or an involute gearing.

The transmitter and/or receiver are designed for example in the manner of an interdigital transducer, although the invention is naturally not tied to a specific transmitter or receiver type. It is furthermore conceivable that the transmitter generates pulses of acoustic waves (in particular surface acoustic waves), e.g. pulses having different frequencies. It is also possible that modulated pulses are used, e.g. frequency- or amplitude-modulated pulses.

The transmitter and/or the receiver are moreover removably connected to the first or the second element, in particular via attaching means. For example, a removable adhesive serves as an attaching means. It is also conceivable that mechanical attaching means are provided, which enable a removable (for instance clamping) attachment of the transmitter and/or receiver on the first or the second element of the gearing arrangement; e.g. via a screw connection or by means of a spring mechanism. A coupling medium can moreover be arranged between the transmitter or the receiver and the first or the second element in order to improve the coupling of acoustic waves into the first or the second element. A possible coupling medium is, for example, a paste-like material having corresponding acoustic properties or a pad made from silicone or another sound-conducting material. It is also conceivable that the transmitter and the receiver form a common structural unit; in particular, the transmitter and the receiver are arranged in a common housing and/or on a common support.

The transmitter and the receiver can moreover be arranged relative to one another such that the acoustic waves propagate at an angle to a tooth flank of the first and/or second element. It is naturally also possible that the transmitter and the receiver are arranged such that the excited acoustic waves propagate parallel to at least some tooth flanks of the gearing.

It is pointed out that a transmitter for generating acoustic waves in the first or the second element is not mandatory. Instead, to realize the invention, it is also possible to use acoustic waves which are produced during the operation of the gearing arrangement, in particular as a result of vibrations or through the movement of components of the gearing arrangement (in particular the first and/or the second element). It is also conceivable that the receiver is realized by a transducer which simultaneously functions as a transmitter. The acoustic waves generated by the transducer are guided such that they can be received by the transducer itself. For example, reflective structures can be provided, with the aid of which the acoustic waves are directed back to the transducer.

The invention also relates to a method for determining properties of a gearing arrangement, in particular using a gearing arrangement as described above, having the steps:
providing at least one first element, which has a gearing, and at least one second element, which cooperates with the first element;
exciting acoustic waves in the first and/or the second element; and
receiving acoustic waves excited in the first and/or the second element by means of a receiver arranged on the first or second element and determining information relating to properties of the gearing arrangement by evaluating a signal generated by the receiver upon receiving the acoustic waves.

In addition to establishing information regarding a lubricant of the gearing arrangement, as addressed above, further properties of the gearing arrangement can be established by evaluating the signal of the receiver, e.g. information regarding a load acting on the gearing arrangement, information regarding a movement of the first or the second element, and/or a defect in the first or the second element can be detected, for instance a defect in a tooth of a gearing of these elements.

The evaluation of the signal of the receiver comprises evaluating an amplitude of a frequency spectrum and/or an envelope of the signal and/or a time interval of structures in the signal, for example. Alternatively or additionally, methods involving pattern identification can also be used to identify patterns in the progression of the receiver signal which can be used for characterizing properties of the gearing arrangement, e.g. for determining the number of teeth in a gearing.

The invention is explained in more detail below with the aid of exemplary embodiments, with reference to the figures, which show:

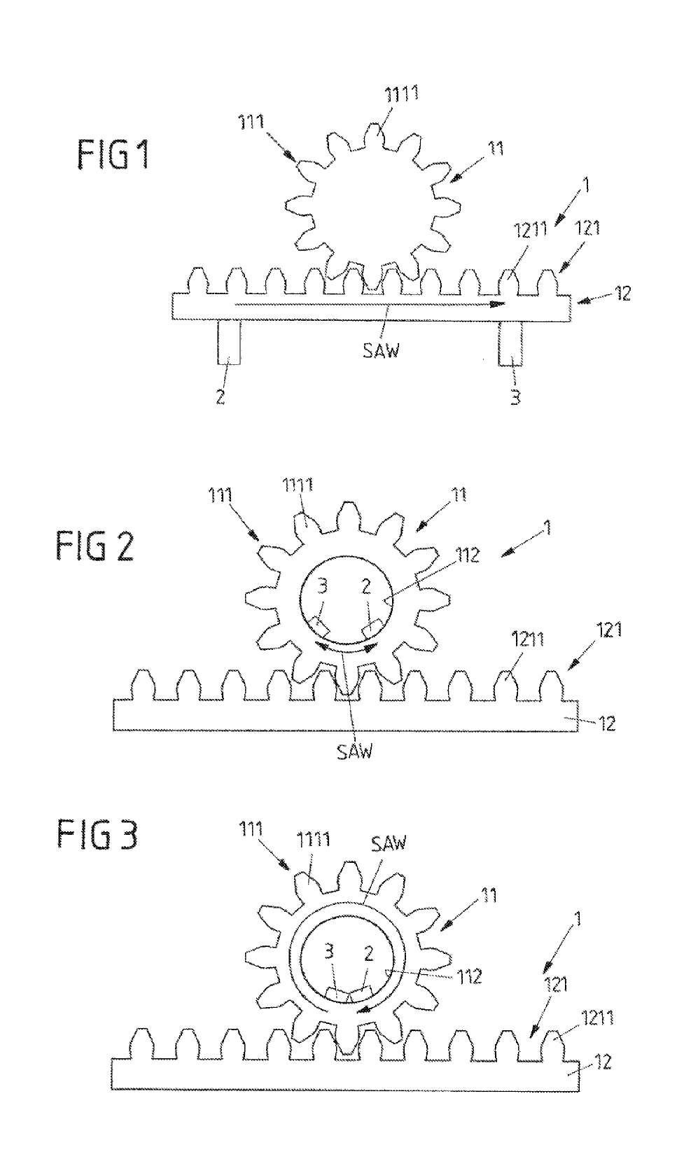

FIG. 1 a gearing arrangement according to a first exemplary embodiment of the invention;

FIG. 2 a gearing arrangement according to a second exemplary embodiment of the invention;

FIG. 3 a modification of the gearing arrangement of FIG. 2;

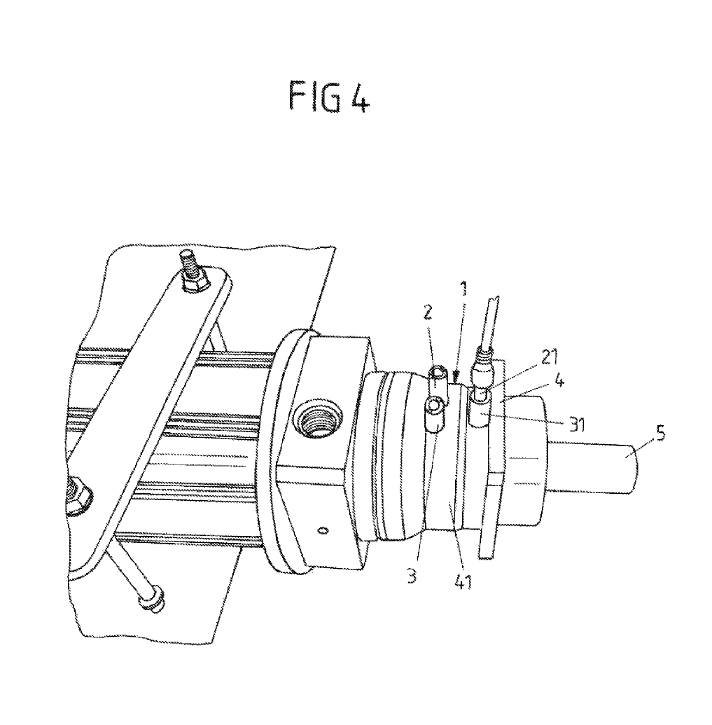

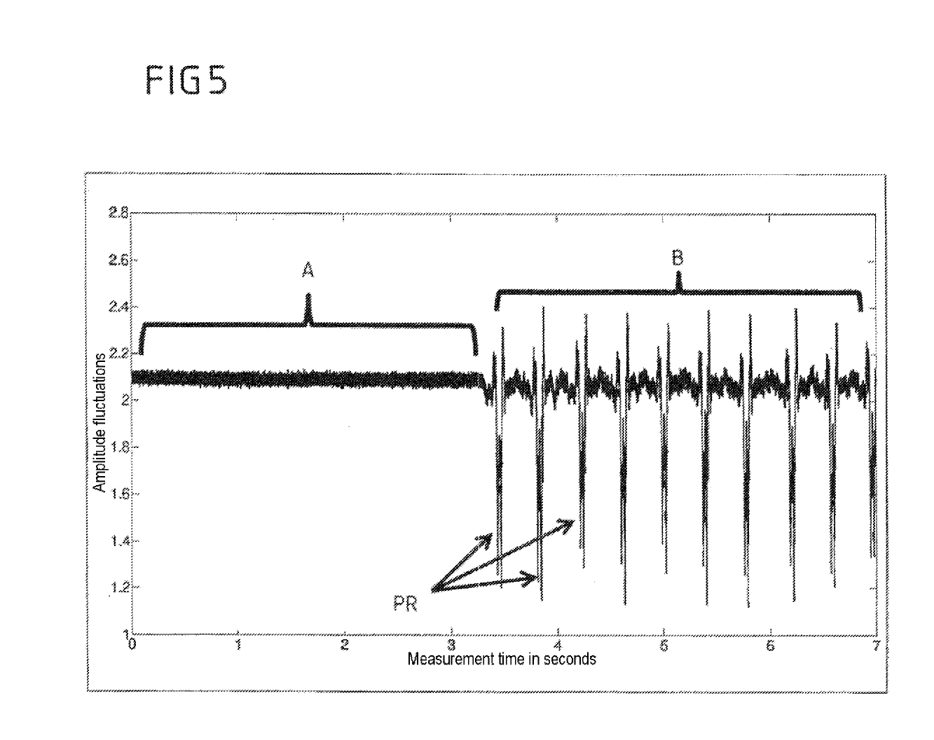

FIG. 4 a perspective view of a gearing arrangement according to a further exemplary embodiment of the invention;

FIG. 5 the signal of an acoustic receiver arranged on the gearing arrangement of FIG. 4;

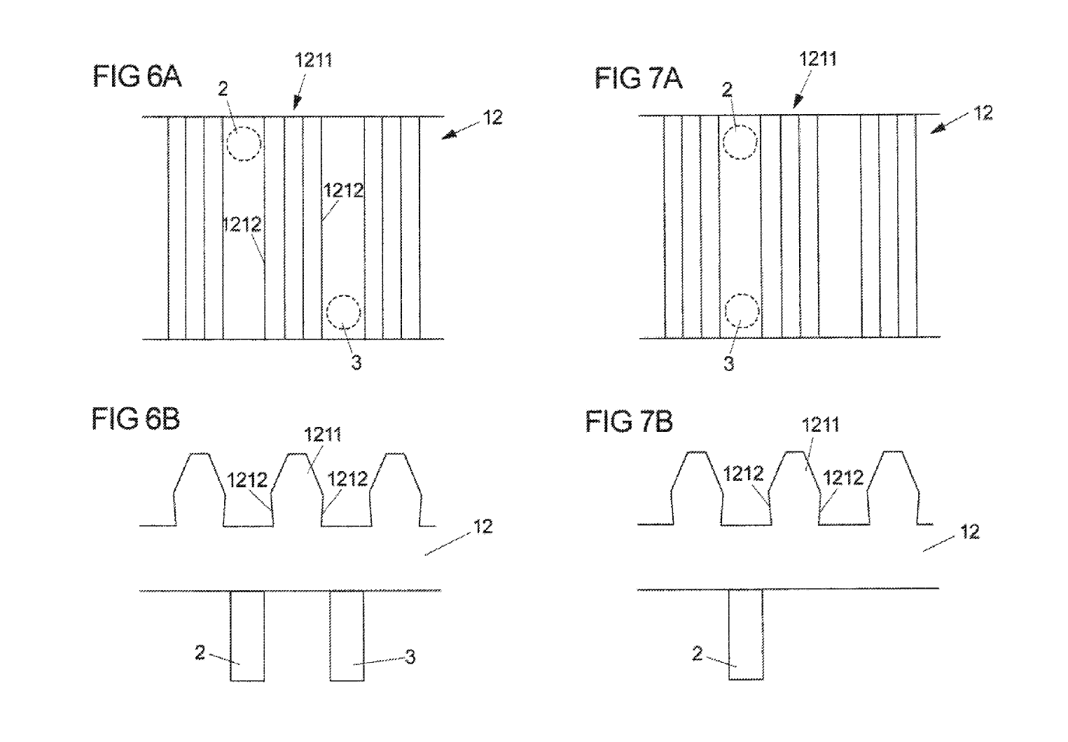

FIG. 6A a gearing arrangement according to a fourth exemplary embodiment in a plan view;

FIG. 6B the gearing arrangement of FIG. 6A in a side view;

FIG. 7A a gearing arrangement according to a fifth exemplary embodiment in a plan view; and

FIG. 7B the gearing arrangement of FIG. 7A in a side view.

The inventive gearing arrangement 1 of FIG. 1 comprises a first element designed as a gear wheel 11 and having an external gearing 111, wherein the gear wheel 11 cooperates with a second element in the form of a gear rack 12. The gear rack 12 has a gearing 121 with a plurality of teeth 1211 which engage in a manner known per se in respective clearances between teeth 1111 of the gearing 111 of the gear wheel 11. Accordingly, a positive-locking coupling between the gear wheel 11 and the gear rack 12 is produced.

A transmitter 2 for generating surface acoustic waves in the gear rack 12 is arranged on a side of the gear rack 12 which is remote from the gear wheel 11. The surface acoustic waves also propagate in particular on the side of the gear rack 12 which faces the gear wheel 11 and has the gearing 121, and more precisely in the direction of a receiver 3 which, like the transmitter 2, is mounted on a side of the gear rack 12 which is remote from the gear wheel 11.

The transmitter 2 and/or the receiver 3 can be connected to the gear rack 12 in a fixed manner. However, it is also conceivable that the transmitter 2 and/or receiver 3 are removably connected to the gear rack 12 (for instance via a removable material-locking connection), as already explained above.

It is possible to establish information relating to the state of the gearing arrangement 1 by evaluating the signal of the receiver 3 upon receiving the surface acoustic waves generated by the transmitter 2. For example, as already mentioned above, the state of a lubricant located between the gear wheel 11 and the gear rack 12 can be established. It is also conceivable that defects in the elements 11, 12, for example a defect in one of the teeth of the gearing of the gear wheel 11 and/or the gear rack 12, become evident from a change in the receiver signal. It is therefore possible to likewise detect such defects by evaluating the receiver signal.

It is, for example, also possible to monitor the quantity of lubricant in a time-dependent manner (in particular during operation of the gearing arrangement 1) with the aid of the receiver signal. Moreover, the entry of a foreign liquid (for example water) into the gearing arrangement could also be ascertained through analysis of the receiver signal. A change in load in the gear arrangement can furthermore be ascertained by evaluating the receiver signal, for example a change in a pre-tension of the gear rack 12 with respect to the gear wheel 11.

It is of course not mandatory that the arrangement comprising the transmitter 2 and receiver 3 is arranged on the gear rack 12. Instead, it is also conceivable that the transmitter and receiver 2, 3 are arranged on the gear wheel 11. To this end, the gear wheel can have a central opening 112, wherein the transmitter 2 and the receiver 3 are arranged on an inner edge of the gear wheel 11 which delimits the cutout 112; c.f. FIG. 2. Accordingly, the surface acoustic waves (SAW) propagate in the gear wheel 11. In particular, the surface acoustic waves SAW extend along a side (having the gearing 111) of the gear wheel 11 which faces the gear rack 12 so that changes in the gearing region can be detected with the aid of the receiver signal. The above explanations relating to FIG. 1 apply analogously.

A modification of FIG. 2 is shown in FIG. 3. In this, the spacing between the transmitter 2 and the receiver 3 is smaller than in FIG. 2; in particular the spacing between the transmitter and receiver 2, 3 is approximately the width of a tooth of the gearing 111. In this arrangement, a receiver signal is preferably evaluated, which is attributed to surface acoustic waves which extend over virtually the entire circumference of the gear wheel 11 (clockwise in FIG. 3). Defects over as wide a region of the gearing 111 as possible can thus be identified by evaluating the receiver signal.

FIG. 4 shows a perspective view of an inventive gearing arrangement 1 combined with a bearing unit 4. The gearing arrangement 1 in this exemplary embodiment is designed in the form of a planetary transmission which has a first element shaped as a ring gear. The ring gear is provided with an internal gearing which cooperates with a planetary gear or with a plurality of planetary gears of the planetary transmission. The ring gear is not shown in FIG. 4 since the planetary transmission as a whole, including the ring gear, is arranged in a housing 41 of the planetary transmission.

The planetary transmission is combined with a bearing 4 via which a shaft 5 cooperating with the planetary transmission is mounted. The bearing 4 is for example a rolling bearing.

A transmitter 2 for generating surface acoustic waves in the ring gear and a receiver 3 for receiving the surface acoustic waves generated by the transmitter 2 are arranged on an outer side of the ring gear. As in the above exemplary embodiments, the arrangement comprising the transmitter 2 and receiver 3 serves for determining properties of the gearing arrangement 1, i.e. in this case the planetary transmission. In particular, it is possible to obtain information relating to the state of a lubricant of the planetary transmission.

FIG. 5 shows a time progression of a signal of the receiver 3 at different points in time; in particular before operation of the planetary transmission and during operation of the planetary transmission 5 (from approximately 3.4 s). It is shown that, before operation of the transmission (time zone “A”), the receiver signal (y axis) is constant up to a noise component. After the initial operation (time zone “B”) of the planetary transmission, periodic fluctuations in the amplitude (with PR minima) of the receiver signal are exhibited, which are attributed to the rotation of the planetary gears of the planetary transmission.

Based on the value of the amplitude and/or the time progression of the receiver signal in the region of its maxima, it is possible to draw conclusions relating to the state of the lubricant in the planetary transmission, for example. The time progression in the region of the signal maxima can be regarded in each case as a “fingerprint” of the planetary gears.

In addition to the measurement at the planetary transmission 5, a measurement can also take place at the bearing 4. To this end, a transmitter 21 for generating surface acoustic waves and a receiver 31 for receiving the generated surface acoustic waves are likewise arranged on an outer side of the housing 41.

FIGS. 6A and 6B relate to a modification of the gearing arrangement 1 of FIG. 1, according to which the transmitter 2 and the receiver 3 are arranged on the gear rack 12 both parallel to the movement direction of the gear rack 12 and offset from one another in a direction parallel to the axis of rotation of the gear wheel 11. In this case, at least one tooth 1211 of the gear rack 12 is located between the transmitter 2 and the receiver 3 so that the surface acoustic waves generated by the transmitter 2 propagate at an angle to side flanks (tooth flanks) 1212 of the tooth 1211 up to the receiver 3.

It is also conceivable that the transmitter 2 and the receiver 3 are arranged parallel to the tooth flanks 1212 of the teeth 1211, i.e. are offset from one another only in a direction parallel to the axis of rotation of the gear wheel 11 (FIG. 7A, 7B). Accordingly, the surface acoustic waves generated by the transmitter 2 propagate at least substantially parallel to the tooth flanks 1212 up to the receiver 3.

### LIST OF REFERENCE SIGNS

1 Gearing arrangement

2, 21 Transmitter

3, 31 Receiver

4 Bearing

5 Shaft

11 Gear wheel

12 Gear rack

111 Gearing of the gear wheel

121 Gearing of the gear rack

1111 Tooth of the gear wheel

1211 Tooth of the gear rack

1212 Tooth flank

1. A gearing arrangement, having
at least one first element (11), which has a gearing (111); and
at least one second element (12), which cooperates with the first element (11),
characterized by
at least one receiver (3) arranged on the first or the second element (11, 12) for receiving acoustic waves (SAW) excited in the first and/or the second element (11, 12), wherein information relating to properties of the gearing arrangement (1) can be determined by evaluating a signal generated by the receiver (3) upon receiving the acoustic waves (SAW).

2. The gearing arrangement as claimed in claim 1, characterized in that the first element (11) is a gear wheel.

3. The gearing arrangement as claimed in claim 1 or 2, characterized in that the first element (11) is a ring gear, in particular a planetary transmission, a bevel gear, a crown gear, a hybrid gear or an elliptical gear.

4. The gearing arrangement as claimed in one of the preceding claims, characterized in that the second element (12) likewise has a gearing (121).

5. The gearing arrangement as claimed in claim 4, characterized in that the second element (12) is a gear rack.

6. The gearing arrangement as claimed in claim 4 or 5, characterized in that tooth flanks of the gearings of the first and the second element (11, 12) extend in a curve or at an angle to a movement direction of the first or the second element (11, 12).

7. The gearing arrangement as claimed in one of claims 4 to 6, characterized in that the gearings of the first and the second element (11, 12) form a cycloidal gearing or involute gearing.

8. The gearing arrangement as claimed in one of the preceding claims, characterized by at least one transmitter (2) for exciting acoustic waves (SAW) in the first and/or second element (11, 12).

9. The gearing arrangement as claimed in claim 8, characterized in that the transmitter (2) is designed to excite surface acoustic waves in the first and/or second element (11, 12).

10. The gearing arrangement as claimed in one of the preceding claims, characterized in that the receiver (3) and the transmitter (2) are arranged on the first element (11) or in that the receiver (3) and the transmitter (2) are arranged on the second element (12).

11. The gearing arrangement as claimed in one of claims 8 to 10, characterized in that the receiver (3) and the transmitter (2) are arranged on a side of the first element (11) which is remote from the gearing (111) or in that the receiver (3) and the transmitter (2) are arranged on a side of the second element (11) which is remote from a gearing (121).

12. The gearing arrangement as claimed in one of claims 8 to 11, characterized in that the first element (11) is a ring gear of a planetary transmission, wherein the transmitter (2) and the receiver (3) are arranged on an outer side of the ring gear.

13. The gearing arrangement as claimed in one of claims 8 to 11, characterized in that the first element (11) is a gear wheel having an external gearing and an opening (112), wherein the transmitter (2) and the receiver (3) are arranged in the opening (112).

14. The gearing arrangement as claimed in one of claims 8 to 13, characterized in that the transmitter (2) and/or the receiver (3) are removably connected to the first or the second element (11, 12) via attaching means.

15. The gearing arrangement as claimed in one of the preceding claims, characterized in that the transmitter (2) and the receiver (3) are arranged such that the acoustic waves (SAW) propagate at an angle to a tooth flank of the first and/or second element (11, 12).

16. A method for determining properties of a gearing arrangement, in particular using a gearing arrangement (1) as claimed in one of the preceding claims, having the steps:
providing at least one first element (11), which has a gearing (111), and at least one second element (12), which cooperates with the first element (11);
exciting acoustic waves (SAW) in the first and/or the second element (11, 12),
characterized by
receiving acoustic waves (SAW) excited in the first and/or the second element (11, 12) by means of a receiver (3) arranged on the first or second element (11, 12) and determining information relating to properties of the gearing arrangement (1) by evaluating a signal generated by the receiver (3) upon receiving the acoustic waves.

17. The method as claimed in claim 16, characterized in that, by evaluating the signal of the receiver (3), properties of a lubricant of the gearing arrangement (1), information regarding a load acting on the gearing arrangement (1) and/or information regarding a movement of the first or the second element (11, 12) are determined and/or a defect in the first or the second element (11, 12) is detected.

18. The method as claimed in claim 16 or 17, characterized in that the evaluation of the signal of the receiver (3) comprises evaluating an amplitude, a frequency spectrum and/or an envelope of the signal and/or a time interval between structures in the signal.

19. The method as claimed in claims 16 to 18, characterized in that the evaluation of the signal of the receiver (3) comprises identifying patterns in the progression of the receiver signal.
